(19) United States
(12) Patent Application Publication
(10) Pub. No.: US 2022/0006184 A1
(43) Pub. Date: Jan. 6, 2022

(54) METHOD AND SYSTEM TO IMPLEMENT NARROWBAND RETRO-REFLECTIVE WAVE MECHANICS

(71) Applicant: Mano D. Judd, Heath, TX (US)

(72) Inventor: Mano D. Judd, Heath, TX (US)

(21) Appl. No.: 16/918,133

(22) Filed: Jul. 1, 2020

(51) Int. Cl. H01Q 3/26; G01S 7/03

(52) U.S. Cl. CPC H01Q 3/26; G01S 7/03

(57) ABSTRACT

Methodology to combine Wave Mechanics with Retro-Reflection, to take in the Far Field emitted (incident) signal via a small array, process the signal and Retro-Reflectively re-transmits the signal back out, with the Wave Mechanics rotation mechanism injected into the array weights. The novelty is using a captured estimate of the incident steering vector, and using each weight to construct the R matrix for a given desired rotation angle. This R matrix is then used to compute a set of transmit weights, that will produce the rotation angle, with an unknown incident signal angle.

The present application claims priority to the earlier filed provisional application having Ser. No. 62/872,446, and hereby incorporates subject matter of the provisional application in its entirety.

### BACKGROUND

Retro-Reflection is defined as a process in which an incident signal is reflected back to the point of origin. In the Radio Frequency (RF) community, Retro-Reflective systems capture the incident RF signal energy and blindly re-transmit this signal. Radar Cross-Eye is one example of a Retro-Reflective System. The term blindly means that no source location or bearing angle information is required. Thus eliminating the need for a complex or expensive passive Direction Finding (DF) system to obtain the incident signal Angle of Arrival (AOA) or Direction of Arrival, and to compute a set of weights that would be used to transmit a copy of the signal back towards the incident signal direction (path). For most Retro-Reflection systems, the output weight vector or steering vector is simply the complex conjugate of the incident signal steering vector. Therefore, one only needs to obtain a course estimate for the incident signal steering vector to construct the conjugate re-transmit steering vector. This can be accomplished simply by collecting a few (array vector) signal samples, and processing them to obtain an estimate of the incident signal steering vector. No further directional processing is then required, and computing the conjugate of the incident signal steering vector is thus trivial.

In U.S. patent application Ser. No. 15,934,563 the Inventor describes a technology and methodology to rotate near field and far field wave fronts, such that the effective transmitted wave front at a point or region in space is not propagating in a direction orthogonal to the direction of travel. This technology is termed “Wave Mechanics” (WM). An RF (or acoustic) array is used to produce a set of transmitted signals, such when these signals constructively and destructively interfere in the far field, the effective wave front is rotated such that in-phase crests and troughs of the wave impinge on target in a pre-determined and calculated direction, that is not orthogonal to the natural expanding path of the wave front.

The “Single Ship” WM model is defined as when all antennas in the array are co-located on a single ship, platform, or compact system. The primary issue with co-location of all antennas within a small area is that the effective size or width of the wave mechanics resultant (width of the expanding wave front in the far field) becomes narrower as the desired rotation angle is increased and as range is increased. In fact, the effective width of this wave field is approximately on the order of the size of the transmit array itself.

For the Single Ship solution, it can be shown that for the very Far Field, that the Electric Field value at the designated points tend to be highly similar in value, independent of the chosen weights. In Ray Theory, this would be discussed as the highly ill-conditioned state where the various Rays tend to be almost perfectly parallel to one another. For single ship solutions, (ie: a large aircraft solution where sub-arrays can be installed at the wing ends) there are likely sufficient angle differences within processing error margin to enable far field rotations with operationally effective rotation angles, from a single ship.

This issue is overcome by generating two or more sub-arrays, that are spaced roughly 2 percent of the range or greater (dual ship or multi-ship models). When this is done, the width of the wave field is literally on the order of the range itself. However, the cost is in the requirement of two or more independent systems, that are also coherently synchronized.

However, the desire for a single ship solution, with large range, on the order or 100 to 500 nautical miles (nmiles) or greater is still highly desired for much smaller platforms, including fighter jets and even small Unmanned Aerial Vehicles (UAVs). The problem is how to accurately and cost effectively project the Wave Mechanics phenomenon at great range, but also to such a small width.

### BRIEF SUMMARY OF THE INVENTION

The Inventor's solution is to combine Wave Mechanics with Retro-Reflection. Thus, the implementation takes in the Far Field emitted signal via numerous “Single Ship” antennas (e.g. the array), processes the signal and Retro-Reflectively re-transmits the signal back out, with the Wave Mechanics rotation mechanism injected into the array weights. The Wave Mechanics implementation of this results in a pre-determined wavefront rotation, as well as much higher received power (at the original emitter), as compared to Cross-Eye that does not generate a controlled rotated wave and requires much higher transmitter power levels. In applying this method, we can overcome the error of the limited Wave Mechanics (Single Ship) wavefront width or corridor.

This Retro-Reflective WM solution requires no estimation or computation of the incident signal Angle of Arrival (AOA), and is effectively blind.

The novelty is using a captured estimate of the incident steering vector, and using each weight to construct the R matrix for a given desired rotation angle. This R matrix is then used to compute a set of transmit weights, that will produce the rotation angle, with an unknown incident signal angle.

### BRIEF DESCRIPTION OF THE DRAWINGS

FIG. 1 shows M antennas in a linear array, spaced by d.

FIG. 2 illustrates Source antennas and Far Field Points

FIG. 3 shows a System using RF Circulators.

FIG. 4 illustrates a System using RF Switches.

### DETAILED DESCRIPTION AND BEST MODE OF IMPLEMENTATION

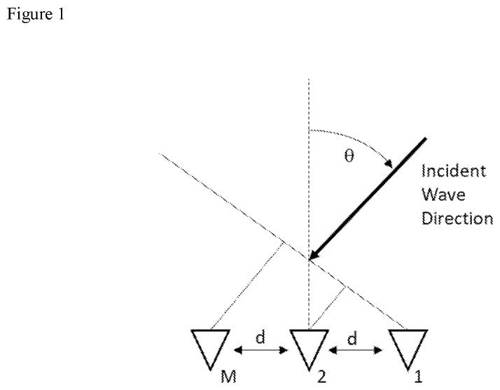

FIG. 1 shows M antennas in a linear array, spaced by d. Assume M antennas. The m^{th} component (m=1, 2, . . . , M) of the steering vector can be represented as:

αₘ=Gₘ(θ)exp^{-j·(m-1)·k·d·sin(θ}^{ᵢ}⁾

Where:

Gₘ(θ)=the antenna voltage of the m^{th} antenna, in the θ direction

K=wave number=2π/λ

d=sensor to sensor spacing, assumed equal in this model.

θᵢ=Incident signal direction of arrival, to the line normal to the array.

This m^{th} component of the steering vector can also be represented as a function of frequency or simply an electrical phase:

$$\begin{matrix}{a}_{m} = {G}_{m} ( θ {θ}_{i} ) {exp}^{- j \cdot ( m - 1 ) \cdot ( ω / c ) \cdot d \cdot sin ( {θ}_{i} )} \\ = {G}_{m} ( {θ}_{i} ) {exp}^{- j \cdot {ϕ}_{m}}\end{matrix}$$

Where:

ω=radial frequency, and

c=speed of light, and

ϕₘ=phase of the m^{th} antenna, relative to a common reference phase

For this simplistic model, the sensor to sensor spacing(s) are assumed equal, however, they can generally be an spacing.

Assume also, for this simplified model, that the antenna gains are equivalent from sensor to sensor, such that:

Gₘ(θᵢ)=G(θᵢ) for all m=1,2, . . . ,M.

Therefore, the Array Factor, for the received signal, can be expressed as:

$$\begin{matrix}A {F}_{r e c} ( θ {θ}_{i} ) = {\sum }_{m = 1}^{M} {A}_{m} \cdot {G}_{m} ( {θ}_{i} ) \cdot {exp}^{- j \cdot ( m - 1 ) \cdot k \cdot d \cdot sin ( {θ}_{i} )} \\ = G ( {θ}_{i} ) {\sum }_{m = 1}^{M} {A}_{m} \cdot {exp}^{- j \cdot ( m - 1 ) \cdot k \cdot d \cdot sin ( {θ}_{i} )}\end{matrix}$$

And the Array factor for the reverse transmitted signal can be expressed as:

$$\begin{matrix}A {F}_{t r a n s m i t ( {θ}_{o} )} = {\sum }_{m = 1}^{M} {B}_{m} \cdot {G}_{m} ( {θ}_{o} ) \cdot {exp}^{- j \cdot ( m - 1 ) k \cdot d \cdot sin ( {θ}_{o} )} \\ = G ( {θ}_{o} ) {\sum }_{m = 1}^{M} {B}_{m} \cdot {exp}^{- j \cdot ( m - 1 ) k \cdot d \cdot sin ( {θ}_{o} )}\end{matrix}$$

Where

Bₘ=the output signal for antenna m

Therefore, to coherently sum in the far field, in the same direction as the receive signal,

Bₘ=G(θᵢ)·exp^{+j·(m-1)·k·d·sin(θ}^{ᵢ}⁾

Therefore, for this coherent summation, θᵢ=θₒ

$$\begin{matrix}A {F}_{t r a n s m i t} ( {θ}_{i} = {θ}_{o} ) = G ( {θ}_{o} ) {\sum }_{m = 1}^{M} G ( {θ}_{o} ) \cdot {exp}^{+ j \cdot ( m - 1 ) \cdot k \cdot d \cdot sin ( {θ}_{o} )} \cdot {exp}^{- j \cdot ( m - 1 ) k \cdot d \cdot sin ( {θ}_{o} )} \\ = {G}^{2} ( {θ}_{o} ) {\sum }_{m = 1}^{M} {exp}^{+ j \cdot ( 0 )} \\ = M \cdot {G}^{2} ( {θ}_{o} )\end{matrix} \qquad$$

Note that the incident phase and the output phases are related by:

ϕₒ=−ϕᵢ=−ϕₒ=conjugate(ϕₒ)

Or that the two phases are simply conjugates of one another. Thus a RetroReflective output signal is simply steered with the conjugate of the incident signal steering vector.

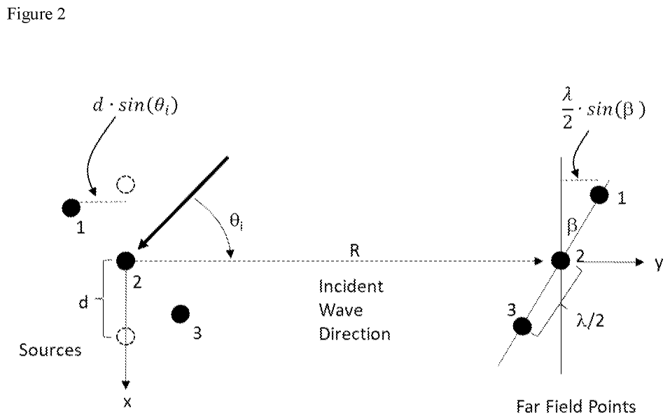

The diagram in FIG. 2 shows three (M=3) source antennas and three (N=3) Far field points. Without loss of generality, the number of sources can be any number, M, and the number of Far-Field points can be any number, N. The incident signal direction, from the middle (center point) antenna in the Far Field is θᵢ. Thus, the steering vector for the three antennas can be represented as:

$$a ( {θ}_{i} ) = [ \begin{matrix}{exp }^{+ j ( 1 ) k \cdot d \cdot sin [ {θ}_{i} ]} \\ {exp }^{ j ( 0 ) k \cdot d \cdot sin [ {θ}_{i} ]} \\ {exp }^{ j ( 1 ) k \cdot d \cdot sin [ {θ}_{i} ]}\end{matrix} ] \qquad$$

Again, it should be noted that the following example is only using M=3 sources and N=M=3 Far-Field points. However, this method can be utilized for any M and N.

This steering vector is easily obtained with the collection of a few data samples (array snapshots), especially for relatively high SNR signals.

A simple Retro-Reflective signal can therefore be produced by transmitting the incident signal, s(t), back with steering weights of conjugate [a(θ₁)].

We are interested in generating a Retro-Reflective Wave Mechanics signal, that would be transmitted from each of the three source antennas. Furthermore, we would want this to be a blind function, that would not require Directing Finding or determination of the Incident Signal Direction, θᵢ. One of the benefits of this approach is that the computation of the required weights, and injection of these weights into a transmitted Retro-Reflective signal could occur in microseconds, with the DSP architecture developing into a custom FPGA module.

Recall that the form of the Wave Mechanics solution, for M transmit antennas and N Far-Field points, is:

$$( s ( t ) {e}^{( j ω t )} ) [ \begin{matrix}\frac{1}{{r}_{11}} {e}^{j k {r}_{11}} & \frac{1}{{r}_{12}} {e}^{j k {r}_{12}} & … & \frac{1}{{r}_{1 M}} {e}^{j k {r}_{1 M}} \\ \frac{1}{{r}_{21}} {e}^{j k {r}_{21}} & \frac{1}{{r}_{22}} {e}^{j k {r}_{22}} & … & \frac{1}{{r}_{2 M}} {e}^{j k {r}_{2 M}} \\ \frac{1}{{r}_{M 1}} {e}^{j k {r}_{M 1}} & \frac{1}{{r}_{M 2}} {e}^{j k {r}_{M 2}} & … & \frac{1}{{r}_{M M}} {e}^{j k {r}_{M M}}\end{matrix} ] [ \begin{matrix}{h}_{1} \\ {h}_{2} \\ ⋮ \\ {h}_{M}\end{matrix} ] = ( s ( t ) {e}^{( j ω t )} ) [ \begin{matrix}{V}_{1} \\ {V}_{2} \\ ⋮ \\ {V}_{M}\end{matrix} ]$$

Where each rₙₘ in the matrix is simply the distance from a Far Field point n, to the source antenna m.

The more compact form of this expression is:

$$\frac{1}{r} [ \begin{matrix}{e}^{{jkr}_{11}} & {e}^{{jkr}_{12}} & … & {e}^{{jkr}_{1 M}} \\ {e}^{{jkr}_{21}} & {e}^{{jkr}_{22}} & … & {e}^{{jkr}_{2 M}} \\ {e}^{{jkr}_{M 1}} & {e}^{{jkr}_{M 2}} & … & {e}^{{jkr}_{M M}}\end{matrix} ] [ \begin{matrix}{h}_{1} \\ {h}_{2} \\ ⋮ \\ {h}_{M}\end{matrix} ] = [ \begin{matrix}{V}_{1} \\ {V}_{2} \\ ⋮ \\ {V}_{M}\end{matrix} ]$$

Where for rₙₘ large, then rₙₘ≈r.

Neglecting the 1/r term as a constant, this expression [00060] can be represented as:

Rₓₓh=V

The key is to estimate the rₘₘ components, in a blind fashion, for a desired Wave rotation angle of β.

Note that in [00057] that N=M has been used. However, in general, Rₓₓ can be a N×M matrix, and V would then be a N×1 vector.

The primary approximation to use in the development, is to assume that for a given source spacing d, or Far Field point separation λ/2, that the y-component of the effective distance will be much larger than the x-component. In general, the Far Field point separation will be less than or equal to λ/2 to reduce spatial aliasing.

For example, using FIG. 2, the distance from source antenna #1 to Far-Field Point #1 can be estimated as:

r₁₁=\sqrt{[d·sin(θᵢ)+R+(λ/2)·sin(β)]²+[d−λ/2]²}

We can see that when R>>d−λ/2 that:

r₁₁≈d·sin(θᵢ)+R+(λ/2)·sin(β)

Using similar reasoning, we can observe that:

r₁₂≈0+R+(λ/2)·sin(β)

r₁₃≈−d·sin(θᵢ)+R+(λ/2)·sin(β)

Therefore, the first row of Rₓₓ would be:

$${\underline{a} ( {θ}_{i} )}_{p o i n t 1} = {{exp}^{k \cdot R \cdot sin [ {θ}_{i} ]} [ \begin{matrix}{exp}^{+ j ( 1 ) \cdot k \cdot d \cdot sin [ {θ}_{i} ]} \cdot {exp}^{+ j ( 1 ) \cdot k \cdot ( λ / 2 ) \cdot s in [ β ]} \\ {exp}^{+ j ( 0 ) \cdot k \cdot d \cdot sin [ {θ}_{i} ]} \cdot {exp}^{+ j ( 1 ) \cdot k \cdot ( λ / 2 ) \cdot sin [ β ]} \\ {exp}^{- j ( 1 ) \cdot k \cdot d \cdot sin [ {θ}_{i} ]} \cdot {exp}^{+ j ( 1 ) \cdot k \cdot ( λ / 2 ) \cdot sin [ β ]}\end{matrix} ]}^{T} \qquad$$

Which is an M×1 vector. Notice the transpose “T”.

It should be noted that for [00051], the first antenna is selected as the reference antenna, where-as in [00075], the middle antenna is selected as the reference antenna. Additionally, in [00075], the first column of delays (complex exponentials) have already been conjugated to produce beamformed transmit outputs, aligned with the incident signal. Thus, it should be noted that the left side column of complex exponentials in [00075] can be easily computed from [00051]. The right side column, which includes the complex exponentials in rotation angle, are easily computed from the known incident signal wavelength, λ, as well as the desired rotation angle, β.

Therefore, another means to implement this would simply be to conjugate the terms in [00051], and use them directly in [00075] for the left side column.

Similarly,

r₂₁≈d·sin(θᵢ)+R+(0)·sin(β)

r₂₂≈0·d·sin(θᵢ)+R+(0)·sin(β)

r₂₃≈d·sin(θᵢ)+R+(0)·sin(β)

Therefore, the second row of Rₓₓ would be:

$${\underline{a} ( {θ}_{i} )}_{p o i n t 2} = {{exp}^{k \cdot R \cdot sin [ {θ}_{i} ]} [ \begin{matrix}{exp}^{+ j ( 1 ) \cdot k \cdot d \cdot sin [ {θ}_{i} ]} \cdot {exp}^{+ j ( 1 ) \cdot k \cdot ( 0 ) \cdot si n [ β ]} \\ {exp}^{+ j ( 0 ) \cdot k \cdot d \cdot sin [ {θ}_{i} ]} \cdot {exp}^{+ j ( 1 ) \cdot k \cdot ( 0 ) \cdot si n [ β ]} \\ {exp}^{ j ( 1 ) \cdot k \cdot d \cdot sin [ {θ}_{i} ]} \cdot {exp}^{+ j ( 1 ) \cdot k \cdot ( 0 ) \cdot si n [ β ]}\end{matrix} ]}^{T} \qquad$$

Finally,

r₃₁≈d·sin(θᵢ)+R−(λ/2)·sin(β)

r₃₂≈0·d·sin(θᵢ)+R−(λ/2)·sin(β)

r₃₃≈−d·sin(θᵢ)+R−(λ/2)·sin(β)

Therefore, the third row of Rₓₓ would be:

$${\underline{a} ( {θ}_{i} )}_{p o i n t 3} = {{exp}^{k \cdot R \cdot sin [ {θ}_{i} ]} [ \begin{matrix}{exp}^{+ j ( 1 ) \cdot k \cdot d \cdot sin [ {θ}_{i} ]} \cdot {exp}^{- j ( 1 ) \cdot k \cdot ( λ / 2 ) \cdot sin [ β ]} \\ {exp}^{+ j ( 0 ) \cdot k \cdot d \cdot s in [ {θ}_{i} ]} \cdot {exp}^{- j ( 1 ) \cdot k \cdot ( λ / 2 ) \cdot sin [ β ]} \\ {exp}^{- j ( 1 ) \cdot k \cdot d \cdot sin [ {θ}_{i} ]} \cdot {exp}^{- j ( 1 ) \cdot k \cdot ( λ / 2 ) \cdot sin [ β ]}\end{matrix} ]}^{T} \qquad$$

We can now approximate the Rₓₓ matrix as:

$$Rxx = [ \begin{matrix}{\underline{a} ( {θ}_{i} )}_{point 1} \\ {\underline{a} ( {θ}_{i} )}_{point 2} \\ {\underline{a} ( {θ}_{i} )}_{p o i n t 3}\end{matrix} ]$$

It should noted that from the original incident steering vector:

$$a ( {θ}_{i} ) = [ \begin{matrix}{exp}^{+ j ( 1 ) \cdot k \cdot d \cdot si n [ {θ}_{i} ]} \\ {exp}^{+ j ( 0 ) \cdot k \cdot d \cdot si n [ {θ}_{i} ]} \\ {exp}^{- j ( 1 ) \cdot k \cdot d \cdot si n [ {θ}_{i} ]}\end{matrix} ] \qquad$$

which has been numerically estimated, a known incident signal carrier frequency, and desired Rotation angle, β, that the Rₓₓ matrix [00092] can be quickly and accurately computed.

Finally, we solve for

Rₓₓh=V

Via a direct matrix inversion, as:

h=Rxx⁻¹V

Or via the use a Genetic Algorithm.

System Implementation:

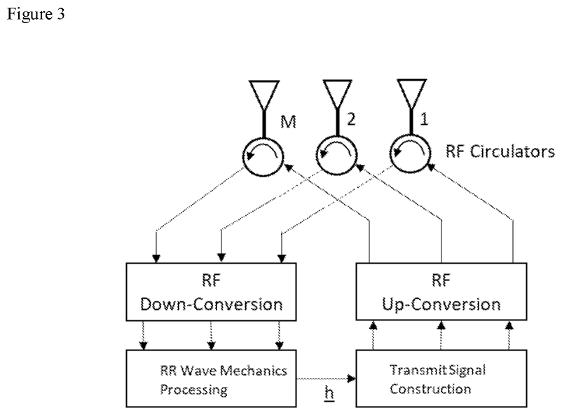

The system in FIG. 3 shows one embodiment of an RF plus digital system that could implement the mechanism described in [00094] through [00099]. Show are three antennas that perform both the transmit and receive functionality. The Incident signal is received through these sensors, and passed through RF Circulators, which are 3-port devices that provide high levels of isolation between RF ports. For example, the port, on each circulator, that attaches to the RF Downconverter path is highly isolated from the port attached to the RF Upconverter path.

It is assumed that the signals from each of the M antennas, in the RF Downconvert path (shown on the left side of FIG. 3) are coherently frequency shifted to baseband, that Retro-Reflective (RR) Wave Mechanics Processor will compute an estimated receive steering vector [00094], the Rₓₓ Matrix [00092], and finally solve for an optimal set of weights h, [00099]. These weights are then sent to the waveform generator, multiplied and form the Transmit Signal Construction stage. These digital signals are then passed through a Digital to Analog (DAC) Converter and RF upconverted (frequency shifted), and finally re-transmitted out the same antennas.

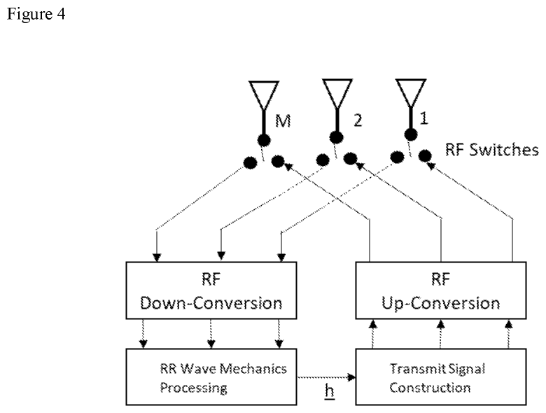

Another embodiment of the invention would include the use of RF Switches, shown in FIG. 4.

Both embodiments function to receive the incident signal, quickly compute the received steering weights (vector), conjugate the weights, multiply by the complex rotation exponentials, and use the resulting matrix to compute a set of transmit weight, h, used to send a rotation signal back to the original source.

### REFERENCES

Judd, M. (2018) U.S. patent application Ser. No. 15,934,563

What is claimed is:

1. A method to combine wave mechanics, U.S. patent application Ser. No. 15,934,563, with retro-reflection, wherein
an incident signal to an array is blindly reflected back to a far field point of origin with a desired wave mechanics wave front rotation angle; and
the effective transmitted wave front at a point or region in space is not propagating in a direction orthogonal to the direction of travel of the reflected wave.

2. The method of claim 1 which takes in the far field emitted signal via a multiplicity of antennas in an array and then processes the signal and retro-reflectively re-transmits the signal back out with the wave mechanics rotation mechanism injected into the array weights.

3. The method of claim 1 that uses a captured estimate of the incident steering vector from a source with an unknown incident signal bearing angle and utilizes each steering vector weight to construct an R-matrix for a user-defined wave mechanics rotation angle wherein the R-matrix is then used to compute a set of transmit weights for the re-transmitted signal from the array which will produce the desired far field rotation angle.

4. The method of claim 1 which obtains the steering vector for the incident signal to the array via the collection of a multiplicity of data samples and uses eigen analysis to obtain the vector associated with the dominant eigenvalue, wherein for high SNR signals a single data sample could be used to estimate the steering vector.

5. The method of claim 1 wherein the rₙₘ components for the R-Matrix are estimated in a blind fashion for any desired Wave rotation angle of β, N is the number of far field wavefield points, and M is the number of antennas in the array.

6. The method of claim 1 wherein the collected steering vector is conjugated, and used to form the R-Matrix.

7. The method of claim 1 wherein the components of the R-Matrix are computed using complex exponentials of the sine of the desired wave mechanics rotation angle.

8. The method of claim 1 wherein Rₓₓ h=V, using a direct matrix inversion approach or a genetic algorithm to obtain the set of weights, h, will solve for the R-matrix.

9. The method of claim 1 wherein no estimation or computation of the incident signal Angle of Arrival (AOA) is required, and is therefore effectively blind.

10. The method of claim 1 which can be utilized for any multiplicity of M antennas or sensors and any N far field or near field points.

11. The method of claim 1 wherein the required weights are computed and these weights are injected into a transmitted retro-reflective signal in microseconds.

12. The system implementation of claim 1 wherein an incident signal is received through sensors in an array and passed through RF circulators and these RF circulators are situated between the antenna and the transceiver system, functioning to receive the incident signal, quickly compute the received steering weights (vector), conjugate the weights, multiply by the complex rotation exponentials, and use the resulting matrix to compute a set of transmit weight, h, used to send a rotation signal back to the original source.

13. The system implementation of claim 12, wherein another embodiment would include the use of RF Switches at each antenna in the array instead of an RF circulator at each antenna.
